(19) United States
(12) Patent Application Publication
(10) Pub. No.: US 2005/0250859 A1
(43) Pub. Date: Nov. 10, 2005

(54) Colloidal system of ceramic nanoparticles

(76) Inventors: Ralph Nonninger, Saarbrucken (DE); Olaf Binkle, Kirkel (DE)

Correspondence Address: Walter A Hackler;Patent Law Office, 2372 S E Bristol Street, Suite B, Newport Beach, CA, 92660-0755, US

(21) Appl. No.: 10/526,442

(22) PCT Filed: Sep. 3, 2002
(86) PCT No.: PCT/DE02/03237

§ 371 Date: Mar. 2, 2005

(51) Int. Cl. B01F 17/00

(52) U.S. Cl. 516/33

(57) ABSTRACT

A colloidal system of ceramic nanoparticles in a dispersion medium is characterized in that the nanoparticles dispersed in the dispersion medium are distributed by 90% or more portions as unimodal nanoparticles having the same particle size in the dispersion medium, wherein the particle size variation decreases from 50%, related to nanoparticles of 1 nm, to 10% for nanoparticles of 100 nm, and the atoms and/or ions located in the surface of the nanoparticles are saturated in terms of valence in dependence on the concentration of the nanoparticles in the dispersion medium using a surface modificator such that an energetic balance of the nanoparticles in the dispersion medium is obtained. The presented colloidal system is characterized by a great stability and keeps the unimodal/monomodal nanoparticles homogeneously distributed and suspended in the dispersion medium.

### BACKGROUND OF THE INVENTION

The present invention concerns a colloidal system with inorganic, oxidic nanoparticles in a dispersion medium and the use thereof to produce ceramic components or to improve material systems which already exist or will be newly created.

Ceramic filtration diaphragms have succeeded in many fields of application compared to diaphragms of polymeric, organic materials, e.g. due to their specific properties. They are superior to those mainly in processes which require high temperature and chemical resistances. The fact that they can be sterilized using vapor, renders them predestined for applications in the food and medical field. The throughput of ceramic diaphragms is up to 1000 times higher than that of organic diaphragms and is influenced only to a small degree by fouling processes due to the inorganic nature of the diaphragm material. The properties of the ceramic diaphragms often offer new fields of application only under the extreme conditions which can be found in many industrial fields.

Filtration processes are subdivided into the tree fields: micro-, ultra- and nano-filtration. Micro-filtration diaphragms have pore sizes of a range above 500 nm. Ultra-filtration utilizes diaphragms with pore sizes of approximately 2 nm to 500 nm. The range of nanofiltration is below this pore size, which therefore represents the transition between ultra-filtration and reverse osmosis. The cut-off value which states the molecular weight of neutral molecules, 90% of which are retained by the diaphragm, is smaller than 1000D for nano-filtration diaphragms. They are therefore suited to enrich or separate ions or organic substances and can be used for gas separation.

The pressures required for nano-filtration are very high due to the small pore sizes, and are in a range between 1 and 4 MPa. Ceramic diaphragms have a much higher pressure resistance than polymer diaphragms due to their higher solidity, such that the diaphragm is not compressed and abrasion through abrasive components in the filtrate is much less. They consequently offer decisive advantages for the use in the field of nano-filtration.

Colloidal sols are mainly used to produce ceramic nano-filtration diaphragms, which can be gained through a sol-gel process. The starting materials for synthesis of the colloids may thereby be salts and also metal alcoxides. The structure of the sols can be influenced to a large degree through hydrolysis and condensation conditions, thereby providing excellent control of the later pore sizes and pore size distributions. A further possibility to produce the colloidal starting systems for the production of the diaphragm layer consists in controlled precipitation of nanoparticles from their salts.

An ultra-filtration diaphragm very frequently serves as carrier layer for the actual nanoporous separating layer, and is coated with the colloidal system using a casting or immersion process. The fine distribution of the precursor substances and thereby of the metal ions forming the ceramic layer permits production of a nanoporous microstructure. The carrier layer provides the diaphragm with the required mechanic solidity and pressure resistance. It is transferred into a nanoporous ceramic layer through drying and/or calcination of the coating.

Dispersions of crystalline nanoparticles are considerably better suited for the production of the ceramic diaphragms for the nano-filtration field than those of amorphous compounds. If amorphous starting systems are used, sintering of the green diaphragm layer often produces cracks due to tension caused by the crystallization process, which are particularly noticeable in the fine microstructures of a nano-filtration diaphragm. Layers of already crystalline particles do not crystallize later and therefore show considerably less tendency to break. Moreover, layers of already crystallized particles can usually be solidified at lower temperatures, thereby again minimizing the forces which occur inside the ceramic.

The separating force of a selective diaphragm layer is substantially determined by the size of its pores and the homogeneity of the pore size distribution. They directly depend on the size of the ceramic particles which were used for producing the diaphragm, since the porosity of the ceramic is determined by the size of the gaps between the individual grains. The largest pores determine the cut-off value of a diaphragm in each case. Errors in the structure in the ceramic diaphragms produce inhomogeneities in the pore size distribution thereby deteriorating the separating performance. Such errors can have the most different causes. They are caused e.g. through inclusions, coarser particles in the ceramic dispersions which are used for diaphragm production, or through agglomerates of the ceramic nanoparticles forming the diaphragm layer.

Such errors cannot be eliminated after production of the diaphragm.

Attempts to produce dispersions with steadily distributed nanoparticles<40 nm have failed up to now due to the high agglomeration tendency of the nanoscale particles. The synthesis of nanoparticles having sizes below 40 nm is often not the problem rather the fact that the systems of the nanoparticles are instable and the particles unavoidably collect to form larger agglomerates whose particle sizes assume values of up to several micrometers. Such agglomerations are irreversible. Separation of the particles is not possible, not even through introduction of large shearing forces into the system.

It is the object of the present invention to provide an agglomeration-free, ceramic nanoparticle dispersion which permits homogeneous and uniform distribution of nanoparticles in material systems to be produced or supplemented.

### SUMMARY OF THE INVENTION

This object is achieved in accordance with the invention in that 90% or more than 90% of the nanoparticles distributed in the dispersion medium have a coinciding particle size, wherein the particle size variation decreases from 50% related to nanoparticles of 1 nm, to 10%for nanoparticles of 100 nm and the atoms and/or ions located in the surface of the nanoparticles are saturated in terms of valence in dependence on the concentration of the nanoparticles in the dispersion medium using a surface modificator, such that an energetic balance of the nanoparticles in the dispersion medium is obtained.

For this reason, the inventive colloidal system has the particular advantage that the nanoparticles are substantially dispersed in the dispersion medium to primary particle size having the same particle size, and are also designed to form a stable colloidal system, in which the nanoparticles are homogeneously distributed over a relatively long period. With such an inventive colloidal system, in which the nanoparticles are distributed in a unimodal/monomodal manner, material systems can be produced and/or supplemented which are highly uniform and have no disturbing points which would restrictively weaken or prematurely limit the system produced by or supplemented with the inventive nanoparticles. The nanoparticles are saturated in the dispersion medium using a surface modificator such that they mutually and permanently keep each other in suspension in the dispersion medium (energetic balance) and growth (agglomeration) of the nanoparticles in the dispersion medium is prevented. Moreover, local concentration densification is eliminated. The particle surface of the nanoparticles dispersed in accordance with the invention contains specific protection which permits production of many novel colloidal systems which produce e.g. in the filter diaphragm production, uniformly distributed, very homogeneous unimodal/monomodal pore sizes of less than 2 nm. Diaphragm errors through uncontrolled agglomerations or particle portions which are too coarse are avoided.

The reduction of the particle size variation from 50% for nanoparticles of 1 nm to 10% for nanoparticles of 100 nm may be non-linear or linear.

The synthesis of nanoparticles can be carried out on the basis of solid, liquid or gaseous systems. The present invention utilizes a wet-chemical method for the particle synthesis.

To prevent subsequent agglomeration of the particles, surface modificators of the most different kinds are used. These substances deposit on the surface of the particles through adsorption processes or through chemical reaction. Depending on the type of surface modificator, the nano-dispersive system is stabilized in an electrostatic, steric or electrosteric manner. The surface energy of the uni-modal nanoparticles is generally reduced in a controlled manner in accordance with the requirements via one or more surface modificators such that the nanoparticles of primary particle size are maintained in a homogeneous distribution in the dispersion medium on a permanent basis.

To stabilize the inventive system of inorganic, oxidic particles, the following surface modificators are preferably used:

Inorganic acids (e.g. HCl), β-diketone, isocyanate, organic acids (e.g. C₂H₄O₂), acid chlorides, acid ester, silanes, polyoxycarboxylic acids.

Each of the mentioned surface modificators may be used individually in the most different concentrations or collectively in the most different proportions with other surface modificators.

These surface modificators even permit drying of the nanoparticles without forming agglomerates. The nanoscale oxides can subsequently be redispersed to their primary particle size in a suitable dispersion medium. Depending on the type of nanoparticles, contents of up to 70 weight % can thereby be obtained without using further methods.

Other nanoparticles can be stabilized or dispersions with a higher content of nanoscale particles can be produced through use of various apparatuses which introduce large shearing energy into the systems. Such a shearing force is not sufficient to separate agglomerated particles, but can prevent agglomeration during processing of particles which are dispersed to primary particle size.

Suitable apparatuses for introducing such shearing energy are: In addition to the three-roll mills: kneaders, mortar mills and/or double screw extruders.

In a further development of the colloidal system, H₂O, alcohol, tetrahydrofuran and/or halogenated hydrocarbons and/or diluted lye and/or diluted acids and/or hydrocarbons and/or aromatic hydrocarbons are used as dispersion medium. The dispersion medium may also consist of mixtures of the mentioned dispersion media with the most different mixing ratios. The mentioned dispersion media can keep the unimodal nanoparticles in a stable and homogeneous manner in the dispersion medium to obtain highest-quality further processing into material systems of the highest quality.

The inorganic oxidic nanoparticles such as titanium dioxide, zirconium dioxide, aluminum oxide, iron oxide, barium titanate or (ITO, tin-doped indium oxide) are obtained e.g. through precipitation and are enriched in the dispersion medium in a permanent and homogeneously distributed manner in a volume percentage of 1-60%. To produce a filter diaphragm, a higher volume percentage of e.g. 35-55% is required and to improve lacquers, a volume percentage of between 1% and 30% is required. Irrespective of the above-mentioned volume percentages, the person skilled in the art may determine his own volume percentage which is optimized for his application, such that e.g. fillers in a plastic material to be supplemented produce the desired new properties of the improved plastic material.

The inventive colloidal system permits improvement of ceramic components, plastic materials etc. The colloidal system may be used as filler for thermal insulation or sound insulation or nano-filtration diaphragms may be produced. Moreover, gas sensors or hollow fibers may be produced from the inventive system, or existing gas sensors, hollow fibers can be supplemented.

A colloidal system of ceramic nanoparticles in a dispersion medium is characterized in that the nanoparticles, which are dispersed in the dispersion medium with 90% and more parts in the dispersion medium, are distributed as unimodal nanoparticles of the same particle size, wherein the particle size variation of 50% related to nanoparticles of 1 nm decreases to 10% for nanoparticles of 100 nm, and wherein the atoms and/or ions located in the surface of the nanoparticles are saturated in the dispersion medium in terms of valence in dependence on the concentration of the nanoparticles using a surface modificator, such that an energetic balance of the nanoparticles in the dispersion medium is obtained. The presented colloidal system is characterized by a large stability and keeps the unimodal/monomodal nanoparticles homogeneously distributed in suspension in the dispersion medium.

1. Colloidal system of ceramic nanoparticles in a dispersion medium, comprising nanoparticles of zirconium dioxide, aluminum oxide, iron oxide or barium titanate which are enriched in volume percentages of 1% to 60% in the dispersion medium, wherein the nanoparticles are dispersed in the dispersion medium in a particle size range of 1 nm to 100 m and the nanoparticles are dispersed substantially to primary particle size in the dispersion medium, 90% or more than 90% of the nanoparticles distributed in the dispersion medium have a coinciding particle size, wherein the particle size variation decreases from 50%, related to nanoparticles of 1 nm, to 10% for nanoparticles of 100 nm, and the atoms and/or ions located in the surface of the nanoparticles are saturated in terms of valence in dependence on the concentration of the nanoparticles in the dispersion medium using a surface modificator such that an energetic balance of the nanoparticles in the dispersion medium is obtained.

2. Colloidal system according to claim 1, wherein an inorganic acid, such as HCl and/or a betadiketone and/or isocyanate, and/or an organic acid such as C₂H₄O₂ and/or acid chlorides and/or acid ester and/or silanes and/or a polyoxycarboxylic acid are added to the dispersion medium as surface modificator.

3. Colloidal system according to claim 1, wherein the dispersion medium is H₂O, alcohol, tetrahydrofuran and/or a halogenated hydrocarbon and/or a diluted acid and/or a diluted lye and/or a hydrocarbon and/or an aromatic hydrocarbon.

4. Use of the colloidal system according to claim 1 as an improving component for ceramic components, plastic materials etc, and as a filler for thermal insulation or sound insulation etc.

5. Use of the colloidal system according to claim 1 as a gas sensor or as a component of a gas sensor.

6. Use of the colloidal system according to claim 1 as a ceramic hollow fiber or as a component of a ceramic hollow fiber.

7. Use of the colloidal system according to claim 1 as a nano-filtration diaphragm or as a component of a nano-filtration diaphragm.
